(19) United States
(12) Patent Application Publication
(10) Pub. No.: US 2008/0266605 A1
(43) Pub. Date: Oct. 30, 2008

(54) IMAGE-PROCESSING UNIT, METHOD, AND COMPUTER-READABLE MEDIUM

(75) Inventor: Yasushi Nishide, Kanagawa (JP)

Correspondence Address: GAUTHIER & CONNORS, LLP, 225 FRANKLIN STREET, SUITE 2300, BOSTON, MA, 02110, US

(73) Assignee: FUJI XEROX CO., LTD., Tokyo (JP)

(21) Appl. No.: 11/939,772

(22) Filed: Nov. 14, 2007

(30) Foreign Application Priority Data
Apr. 27, 2007 (JP) 2007119807

(51) Int. Cl. G06K 15/00

(52) U.S. Cl. 358/1.17

(57) ABSTRACT

An image-processing unit includes: a common drawing data acquisition component that acquires drawing data for a unit page containing a common image in variable printing whereby a plurality of pages are printed, with each of the pages having an image that is common among the pages and an image that is variable from page to page, the images being compounded; a variable drawing data acquisition component that acquires drawing data for a unit page containing the variable image at each page in the variable printing; a specification component that specifies, for each of the pages, a region where the common image is positioned over the variable image, among regions where the variable image is positioned; and a generation component that overwrites the common drawing data with the variable drawing data so as not to overwrite the specified region, and generates drawing data for variable printing.

### CROSS-REFERENCE TO RELATED APPLICATIONS

This application is based on and claims priority under 35 USC 119 from Japanese Patent Application No. 2007-119807 filed on Apr. 27, 2007.

### BACKGROUND

1. Technical Field

The present invention relates to an image-processing unit, a method, and a computer-readable medium.

2. Related Art

Variable printing is known, whereby multiple pages are printed, with each page having an image that is common among the pages and an image that varies from page to page, the images being compounded.

In the variable printing, there exists one method whereby raster data containing a common image for a unit page and raster data containing a variable image for a unit page are created, and the two sets of raster data are compounded to obtain raster data for variable printing.

### SUMMARY

According to an aspect of the present invention, there is provided an image-processing unit including: a common drawing data acquisition component that acquires drawing data for a unit page containing a common image (hereinafter referred to as common drawing data) in variable printing whereby a plurality of pages are printed, with each of the pages having an image that is common among the pages and an image that is variable from page to page, the images being compounded; a variable drawing data acquisition component that acquires drawing data for a unit page containing the variable image at each page (hereinafter referred to as variable drawing data) in the variable printing; a region specification component that specifies, for each of the pages, a region where the common image is positioned over the variable image, among regions where the variable image is positioned; and a drawing data generation component that overwrites, for each of the pages, the acquired common drawing data with the acquired variable drawing data so as not to overwrite the specified region, and generates drawing data for variable printing for a unit page.

### BRIEF DESCRIPTION OF THE DRAWINGS

Exemplary embodiments of the present invention will be described in detail by reference to the following figures, wherein:

FIG. 1 is a block diagram showing an example configuration of a print system including an image-processing unit according to an exemplary embodiment;

FIG. 2 is a block diagram showing an example configuration of an image-processing section;

FIG. 3 is a flow chart showing an example operation procedure of the image-processing section;

FIG. 4 is a conceptual diagram showing an example of information for variable printing; and

FIG. 5 is a conceptual diagram showing an example of processing for generating drawing data for variable printing from the information for variable printing shown in FIG. 4.

### DETAILED DESCRIPTION

An exemplary embodiment of the present invention will be described below with reference to the drawings.

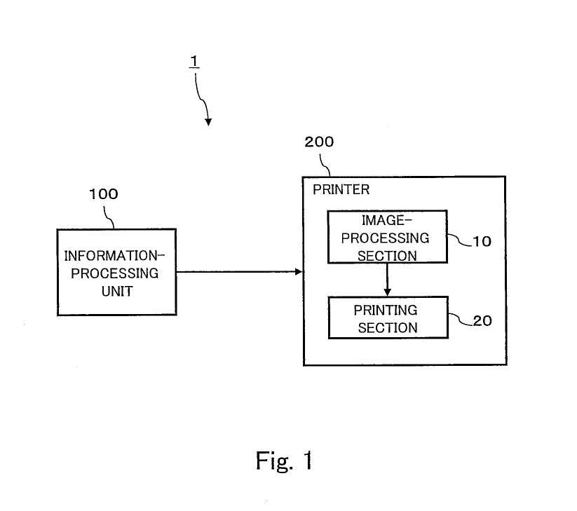

FIG. 1 is a block diagram showing an example configuration of a print system 1 including an image-processing unit according to the present exemplary embodiment. This print system 1 is a system that performs variable printing, whereby multiple pages are printed, with each page containing an image that is common among the pages and an image that is variable from page to page, the images being compounded. Note that, in the following description, the “image that is common among the pages” is referred to as “common image,” and the “image that is variable from page to page” is referred to as “variable image.” A common image is also called a master image, and a variable image is also called a variable image.

As shown in FIG. 1, the print system 1 includes an information-processing unit 100 and a printer 200. The information-processing unit 100 and the printer 200 are connected so as to communicate with each other by way of cable or radio.

The information-processing unit 100 is a device that sends information for variable printing to the printer 200, is realized by a computer, and, for example, is a personal computer, a server, or the like. Here, the information for variable printing is data described by a language corresponding to variable printing, such as Personalized Printing Markup Language (PPML).

The printer 200 is a device that receives the information for variable printing from the information-processing unit 100, and performs variable printing by reference to the information. The printer 200 has an image-processing section 10 and a printing section 20.

The image-processing section 10 generates drawing data for variable printing and passes the drawing data to the printing section 20. This image-processing section 10 is realized, for example, by a computer, and various processes in the image-processing section 10 are realized by reading out to a main memory an image-processing program stored in a storage medium such as a read-only memory (ROM), and executing the program by a central processing unit (CPU).

The image-processing program can be provided after being stored in a storage medium such as a CD-ROM, or provided by communication as a data signal. However, some or all of the processing of the image-processing section 10 may be realized by only hardware.

The printing section 20 receives the drawing data from the image-processing section 10, and prints an image based on the drawing data onto print media such as paper, by means of an electrophotography method or an ink jet method.

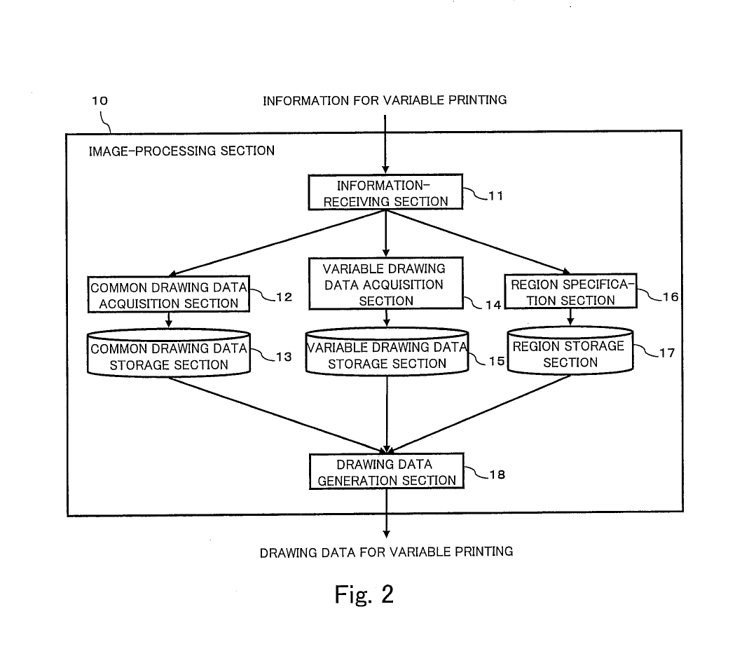

FIG. 2 is a block diagram showing an example configuration of the image-processing section 10. The configuration of the image-processing section 10 will be described below with reference to FIG. 2.

As shown in FIG. 2, the image-processing section 10 includes an information-receiving section 11, a common drawing data acquisition section 12, a common drawing data storage section 13, a variable drawing data acquisition section 14, a variable drawing data storage section 15, a region specification section 16, a region storage section 17, and a drawing data generation section 18.

The information-receiving section 11 receives the information for variable printing from the information-processing unit 100. Here, the information for variable printing includes the following information (a) to information (c).

(a) image data of one or more component images that are common among the pages (hereinafter referred to as “common component image”)

(b) image data of one or more component images that are variable from page to page (hereinafter referred to as “variable component image”)

(c) page configuration information indicating the position of each common component image on a page, the variable component image positioned on each page, the position of each variable component image on each page, and the top-bottom relationship among the component images on each page.

Here, in the present specification, the top-bottom relationship among images means the top-bottom relationship in the hierarchical structure of an image. That is to say, in the relationship among images, “top” means a visible side (the side near to a viewer, also referred to as a front side), and “bottom” means a non-visible side (side distant from a viewer, also referred to as a back side). Therefore, for example, an expression such as “image B is positioned over image A” means that the image B is positioned on the visible side (front side) of the image A.

Note that the information-receiving section 11 may receive the information (a) to information (c) as one group, or separately.

The common drawing data acquisition section 12 acquires drawing data for a unit page containing a common image (hereinafter referred to as “common drawing data”) in the variable printing. Here, drawing data are data that represent an image as the aggregate of colored points (pixels); for example, raster data.

In the present exemplary embodiment, the common drawing data acquisition section 12 draws image data of the common component image received by the information-receiving section 11, on the basis of page configuration information received by the information-receiving section 11, and generates, as common drawing data, drawing data for a unit page where one or more common component images are positioned. At that time, each common component image is positioned on the position on the page of the common component image, which is indicated by the page configuration information. In addition, each common component image is positioned according to the top-bottom relationship among common component images indicated by the page configuration information.

In addition, in the present exemplary embodiment, the common drawing data acquisition section 12 stores the acquired common drawing data in the common drawing data storage section 13.

The common drawing data storage section 13 stores the common drawing data acquired by the common drawing data acquisition section 12.

The variable drawing data acquisition section 14 acquires drawing data for a unit page containing a variable image at each page (hereinafter referred to as “variable drawing data”) in the variable printing.

In the present exemplary embodiment, on the basis of the page configuration information received by the information-receiving section 11, the variable drawing data acquisition section 14, for each page, draws image data of the variable component image received by the information-receiving section 11 and generates, as variable drawing data, drawing data for a unit page where the variable component image is positioned. At that time, the variable component image positioned on the page indicated by the page configuration information is positioned on the variable drawing data of each page. In addition, for each page, each variable component image is positioned at the position on the page of the variable component image, which is indicated by the page configuration information. In addition, for each page, each variable component image is positioned according to the top-bottom relationship among variable component images indicated by the page configuration information.

On the variable drawing data, pixels in a region where no variable component image is positioned are set to colorless pixels (also referred to as invalid pixels).

According to one aspect, the variable drawing data includes first data that include a pixel value corresponding to each of multiple pixels, which are two-dimensionally arranged, and second data that include information indicating whether or not the pixel corresponding to each of multiple pixels is colorless. Then, the pixels in the region where no variable component image is positioned are set to colorless in the second data.

The information indicating whether or not a pixel is colorless is, for example, one-bit information indicating that “one” is not colorless (valid), and “zero” is colorless (invalid). Hereinafter, information indicating whether or not a pixel is colorless is referred to as a valid bit. In this case, among valid bits contained in the second data, a valid bit corresponding to pixels in the region where no variable component image is positioned is set to “zero.”

According to another aspect, the variable drawing data include a pixel value corresponding to each of multiple pixels, which are two-dimensionally arranged, and each of the pixel values may take on a value corresponding to colorless. According to this aspect, among pixel values contained in the variable drawing data, the pixel values of the pixels in the region where no variable component image is positioned are set to a value corresponding to colorless.

The variable drawing data storage section 15 stores the variable drawing data acquired by the variable drawing data acquisition section 14.

For each page, the region specification section 16 specifies a region where a common image is positioned over a variable image, among regions where a variable image is positioned.

According to the present exemplary embodiment, the region specification section 16 specifies the region on the basis of the page configuration information received by the information-receiving section 11. More specifically, the region specification section 16 specifies the region, on the basis of the position of each common component image on the page, the variable component image positioned on each page, the position of each variable component image on each page, and the top-bottom relationship among component images on each page, which are indicated by the page configuration information.

The region storage section 17 stores information indicating the region specified by the region specification section 16.

For each page, the drawing data generation section 18 compounds the common drawing data acquired by the common drawing data acquisition section 12 and the variable drawing data acquired by the variable drawing data acquisition section 14, and generates drawing data for variable printing for a unit page. More specifically, for each page, the drawing data generation section 18 overwrites the common drawing data acquired by the common drawing data acquisition section 12 with the variable drawing data acquired by the variable drawing data acquisition section 14 so as not to overwrite the region specified by the region specification section 16, and generates the drawing data for variable printing for a unit page.

According to the present exemplary embodiment, the drawing data generation section 18 performs processing whereby the pixels in the specified region in the variable drawing data are set to colorless pixels, and overwrites the common drawing data with the processed variable drawing data.

According to one aspect, the drawing data generation section 18 sets the pixels in the specified region to colorless in the second data of the variable drawing data. For example, the drawing data generation section 18 sets the valid bits corresponding to the pixels in the specified region in the second data to “zero.” Then, the drawing data generation section 18, referring to the second data, substitutes the pixel value of the common drawing data with the pixel value of the first data for all the pixels not set to colorless in the second data (for example, a valid bit is “one”), thereby turning the common drawing data after substitution into drawing data for variable printing for a unit page.

According to another aspect, the drawing data generation section 18 sets the pixel values of the pixels in the specified region in the variable drawing data to a value corresponding to colorless. Then the drawing data generation section 18 substitutes the pixel value of the common drawing data with the pixel value of the variable drawing data for all pixels except for pixels having a pixel value corresponding to colorless, thereby turning the common drawing data after substitution into drawing data for variable printing for a unit page.

In addition, according to the present exemplary embodiment, the drawing data generation section 1B uses the common drawing data stored in the common drawing data storage section 13 to generate drawing data for variable printing. According to one aspect, the common drawing data, once having been acquired by the common drawing data acquisition section 12 and stored, are used on multiple pages.

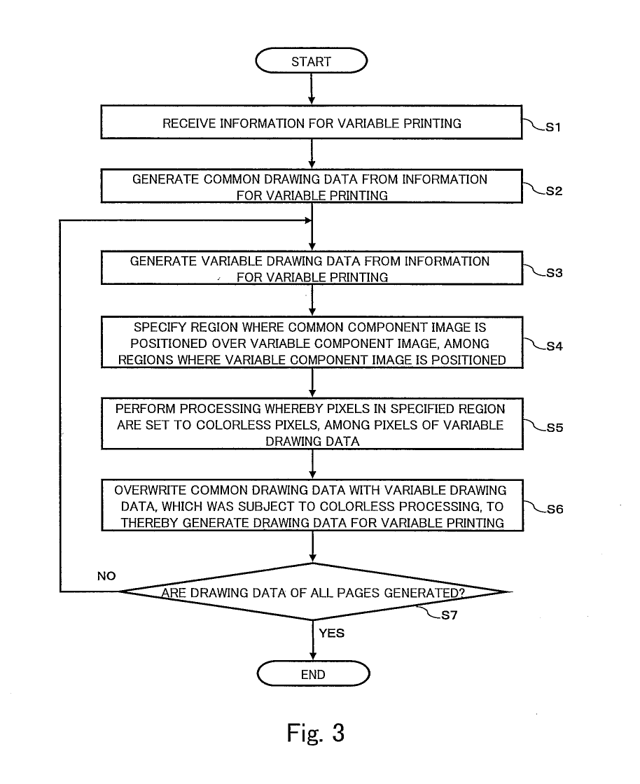

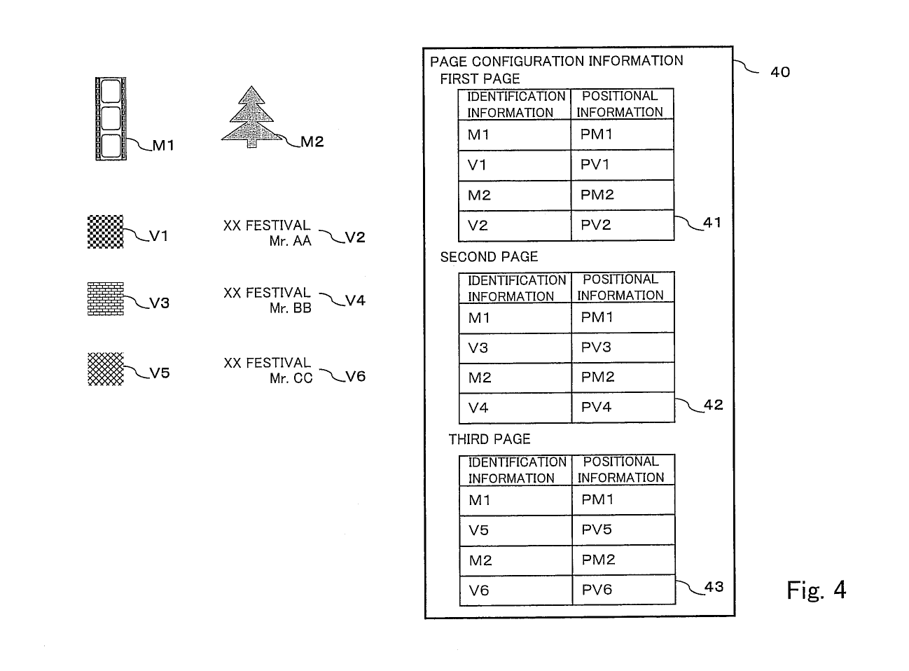

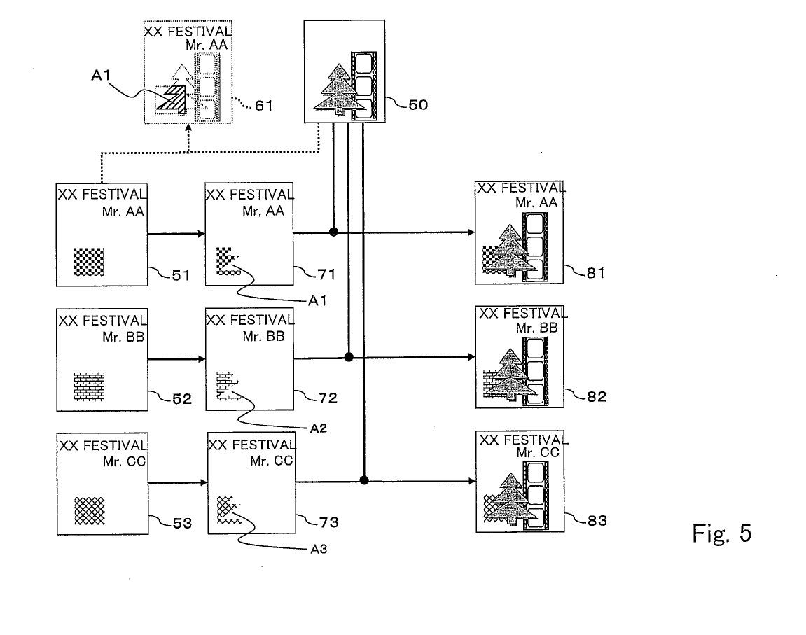

FIG. 3 is a flow chart showing an example of the procedure of the operation of the image-processing section 10. FIG. 4 is a conceptual diagram showing an example of information for variable printing. FIG. 5 is a conceptual diagram showing an example of processing for generating drawing data for variable printing from the information for variable printing shown in FIG. 4. The operation of the print system 1 according to the present exemplary embodiment will be described below with reference to FIGS. 3 to 5.

First, the information-processing unit 100 sends the information for variable printing to the printer 200 in response to an instruction by a user, for example.

The image-processing section 10 of the printer 200 receives the information for variable printing from the information processing unit 100 (S1). In the example of FIG. 4, the information for variable printing includes image data of two common component images M1 and M2, image data of six variable component images V1 to V6, and page configuration information 40. The page configuration information 40 includes configuration information 41 to configuration information 43 for the first to third pages, respectively. Each of the configuration information 41 to configuration information 43 includes four sets of component image layout information arranged vertically in predetermined order. Each component image layout information includes identification information for identifying a component image, and positional information for indicating the position of the component image on a page. In each of the configuration information 41 to configuration information 43, the order of arrangement of the component image layout information indicates the order of the component images in the vertical arrangement, and the top position in the order of arrangement of the component image layout information corresponds to the bottom layer of the top-bottom relationship among the component images. That is to say, on the first page (configuration information 41), the order of arrangement of the component image layout information is M1, V1, M2 and V2 sequentially from the top; therefore, the top-bottom relationship among the component images is V2, M2, V1, and M1 sequentially from the top (from a viewer).

Then, the image-processing section 10 generates and stores common drawing data on the basis of the information for variable printing received in step S1 (S2). In the examples of FIGS. 4 and 5, the image-processing section 10, referring to the configuration information 41 for the first page, specifies the identification information M1 and identification information M2 of the common component image contained in the configuration information 41, the positional information PM1 and positional information PM2 of the common component image, and the top-bottom relationship among the common component images. Then, the image-processing section 10 rasterizes the image data of the common component images M1 and M2 to generate common drawing data 50, which is raster data for a unit page, so that the common component image M1 identified by the identification information M1 is positioned on the position on the page indicated by the positional information PM1, the common component image M2 identified by the identification information M2 is positioned on the position on the page indicated by the positional information PM2, and the common component image M2 is positioned on the upper side of the common component image M1. According to one aspect in this case, the image-processing section 10 generates image data where the common component images M1 and M2 are positioned from the image data of the common component images M1 and M2, and rasterizes the image data to generate raster data for a unit page.

Then, the image-processing section 10 performs processing for generating drawing data for variable printing of the first page (S3 to S6).

That is to say, the image-processing section 10 generates and stores variable drawing data for the first page on the basis of the information for variable printing received in step S1 (S3). In the examples of FIGS. 4 and 5, the image-processing section to, referring to the configuration information 41 for the first page, specifies the identification information V1 and identification information V2 of the variable component image contained in the configuration information 41, the positional information PV1 and positional information PV2 of the variable component image, and the top-bottom relationship among the variable component images. Then the image-processing section 10 rasterizes the image data of the variable component images V1 and V2 to generate variable drawing data 51, which are raster data for a unit page, so that the variable component image V1 identified by the identification information V1 is positioned at the position on the page indicated by the positional information PV1, the variable component image V2 identified by the identification information V2 is positioned at the position on the page indicated by the positional information PV2, and the variable component image V2 is positioned at the upper side of the variable component image V1. According to one aspect in this case, the image-processing section 10 generates image data where the variable component images V1 and V2 are positioned from the image data of the variable component images V1 and V2, and rasterizes the image data to generate raster data for a unit page.

Note that, in FIG. 5, virtual drawing data 61 for a unit page is indicated by a dotted line, in which the common drawing data 50 generated in step S2, and the variable drawing data 51 obtained in step S3 are simply overlapped.

Then, on the basis of the information for variable printing received in step S1, for the first page, the image-processing section 10 specifies a region where the common component image is positioned over the variable component image, among regions where the variable component image is positioned, and stores information indicating the region (S4). In the examples of FIGS. 4 and 5, since the variable component image V1 and the common component image M2 are overlapped, and the common component image M2 is positioned over the variable component image V1, the image-processing section 10 specifies a region in which the variable component image V1 and the common component image M2 are overlapped (diagonally shaded region A1 in the drawing data 61 in FIG. 5).

Then, the image-processing section 10 performs processing whereby the pixels in the region indicated by the information stored in step S4 are set to colorless pixels, among pixels of the variable drawing data stored in step S3 (S5). In the examples of FIGS. 4 and 5, the image-processing section 10 sets the pixels in the region A1 in the variable drawing data 51 to colorless to acquire variable drawing data 71 after colorless processing. According to one aspect, the image-processing section 10 clears the valid bits of the pixels in the region A1 in the variable drawing data 51. In addition, according to another aspect, the image-processing section 10 sets the pixel value of the pixels in the region A1 in the variable drawing data 51 to a value corresponding to colorless.

Then, the image-processing section 10 overwrites the common drawing data stored in step S2 with the variable drawing data on which the colorless processing is performed in step S5 to generate drawing data of the first page for variable printing for a unit page (S6). In the examples of FIGS. 4 and 5, the image-processing section 10 overwrites the common drawing data 50 with the variable drawing data 71 after the colorless processing to acquire drawing data 81 of the first page. In this case, since the pixels in the region A1 in the variable drawing data 71 have been set to colorless, the pixels in the region A1 in the common drawing data 50 are not overwritten.

Then, the image-processing section 10 determines whether or not the generation of the drawing data of all the pages is completed (S7), and, when determining the generation to be completed (S7: YES), finishes the processing; on the other hand, when determining the generation not to be completed (S7: NO), returns the processing to step S3 where the generation of drawing data of the next page is performed. That is to say, the image-processing section 10 repeatedly performs the processing of steps S3 to S6 for the number of pages to generate the drawing data of all the pages. Note that the common drawing data are common among the pages; therefore, the common drawing data generated in step S2 are used repeatedly. In the examples of FIGS. 4 and 5, after generating the drawing data 81 of the first page, the image-processing section 10 generates variable drawing data 52 for the second page (S3), specifies a region A2 where the common component image is positioned over the variable component image in the second page (S4), sets the pixels in the region A2 in the variable drawing data 52 to colorless to thereby generate variable drawing data 72 after colorless processing (S5), and overwrites the common drawing data 50 with the variable drawing data 72 to generate drawing data 82 of the second page (S6). Then, as above, the image-processing section 10 generates variable drawing data 53 for the third page (S3), specifies a region A3 (S4), generates variable drawing data 73 after colorless processing (S5), and overwrites the common drawing data 50 with the variable drawing data 73 to thereby generate drawing data 83 of the third page (S6).

The drawing data for variable printing of each page, having been generated by the above processing, are passed by the image-processing section 10 to the printing section 20, and printed on print media by the printing section 20. Here, the drawing data for variable printing of each page may be printed at suitable timing; for example, each time the data are generated, or may be printed in one block after the drawing data for all the pages have been generated.

Note that, although, in the above description the configuration in which common drawing data are overwritten with variable drawing data has been illustrated, a configuration in which variable drawing data are overwritten with common drawing data may be considered. In this configuration, for each page, the region specification section 16 specifies a region where a variable image is positioned over a common image, among regions where a common image is positioned. In addition, for each page, the drawing data generation section 18 overwrites the variable drawing data acquired by the variable drawing data acquisition section 14 with the common drawing data acquired by the common drawing data acquisition section 12 so as not to overwrite the region specified by the region specification section 16, and generates the drawing data for variable printing for a unit page. According to one aspect, the drawing data generation section 18 performs processing whereby the pixels in the specified region in the common drawing data are set to colorless pixels, and overwrites the variable drawing data with the processed common drawing data.

In addition, although in the above description the configuration in which the common drawing data acquisition section 12 performs drawing processing to generate common drawing data has been illustrated, the common drawing data acquisition section 12 may receive common drawing data that have been generated outside (for example, in the information-processing unit 100). In this case, the common drawing data acquisition section 12 may store the received common drawing data in the common drawing data storage section 13, and the drawing data generation section 1B may use the stored common drawing data to generate drawing data for variable printing. According to one aspect, the common drawing data, once received and stored by the common drawing data acquisition section 12, are used on multiple pages. Note that the information-processing unit 100 is a personal computer, a server, or the like.

In addition, the image-processing section 10 may be configured as follows. The common drawing data acquisition section 12 acquires common drawing data in advance where one or more component images that are common among the pages (common component image) are positioned, and stores the common drawing data in the common drawing data storage section 13. For example, the common drawing data acquisition section 12 receives and stores the common drawing data in advance, or generates and stores common drawing data in advance. The information-receiving section 11 receives image data of one or more component images that are variable from page to page (variable component image), and page configuration information indicating the position of each common component image on a page, the variable component image positioned on each page, the position of each variable component image on each page, and the top-bottom relationship among component images on each page. On the basis of the page configuration information, the variable drawing data acquisition section 14, for each page, draws the image data of the variable component image, and generates the drawing data (variable drawing data) for a unit page where the variable component image is positioned. The region specification section 16 specifies a region on the basis of the page configuration information. On the basis of the specified region, the drawing data generation section 18 uses the stored common drawing data and the generated variable drawing data to generate drawing data for variable printing. In this configuration, since common images are stored in advance as drawn data, the image-processing section 10 generates drawing data for variable images.

In addition, although in the above description configuration in which the variable drawing data acquisition section 14 performs drawing processing to generate variable drawing data has been illustrated, the variable drawing data acquisition section 14 may receive variable drawing data that has been generated outside (for example, in the information-processing unit 100). Note that the information-processing unit 100 is a personal computer, a server, or the like.

In addition, although in the above description the configuration in which the image-processing section 10 is included in the printer 200 has been illustrated, the image-processing section 10 may be outside the printer 200, and may be realized by the information-processing unit 100, for example. Note that the information-processing unit 100 is a personal computer, a server, or the like.

In addition, printing processing that includes variable printing may include printing processing other than variable printing. For example, variable printing may be performed on multiple pages in a specific portion among multiple pages in the printing processing. For example, in double-sided printing, even-number pages may be subjected to variable printing, and odd-number pages may be subjected to printing other than variable printing. In this case, common drawing data are not common among all the printing pages, but are common among even-number pages, which are subjects of variable printing.

In addition, printing processing that includes variable printing may include multiple variable printings. In this case, in the printing processing, multiple types of common drawing data are used. For example, in printing of direct mail, first common drawing data may be used for multiple destinations, and second common drawing data different from the first common drawing data may be used for other multiple destinations.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with various modifications as are suited to the particular use contemplated. It is intended that the scope of the invention be defined by the following claims and their equivalents.

What is claimed is:

1. An image-processing unit comprising:
a common drawing data acquisition component that acquires drawing data for a unit page containing a common image (hereinafter referred to as common drawing data) in variable printing whereby a plurality of pages are printed, with each of the pages having an image that is common among the pages and an image that is variable from page to page, the images being compounded;
a variable drawing data acquisition component that acquires drawing data for a unit page containing the variable image at each page (hereinafter referred to as variable drawing data) in the variable printing;
a region specification component that specifies, for each of the pages, a region where the common image is positioned over the variable image, among regions where the variable image is positioned; and
a drawing data generation component that overwrites, for each of the pages, the acquired common drawing data with the acquired variable drawing data so as not to overwrite the specified region, and generates drawing data for variable printing for a unit page.

2. The image-processing unit according to claim 1, wherein
the drawing data generation component performs processing whereby pixels in the specified region in the variable drawing data are set to colorless pixels, and overwrites the common drawing data with the processed variable drawing data.

3. The image-processing unit according to claim 1, wherein
the common drawing data acquisition component stores the common drawing data in a memory, and
the drawing data generation component uses the stored common drawing data to generate drawing data for the variable printing.

4. The image-processing unit according to claim 2, wherein
the common drawing data acquisition component stores the common drawing data in a memory, and
the drawing data generation component uses the stored common drawing data to generate drawing data for the variable printing.

5. The image-processing unit according to claim 1, further comprising:
an information-receiving component that receives image data of one or more component images that are common among the pages (hereinafter referred to as common component image), image data of one or more component images that are variable from page to page (hereinafter referred to as a variable component image), and page configuration information indicating the position of each common component image on a page, a variable component image positioned on each of the pages, the position of each variable component image on each of the pages, and the top-bottom relationship among component images on each of the page, wherein
the common drawing data acquisition component draws image data of the common component image to thereby generate drawing data for a unit page where the common component image is positioned, on the basis of the page configuration information,
the variable drawing data acquisition component, for each of the pages, draws image data of the variable component image and generates drawing data for a unit page where the variable component image is positioned, on the basis of the page configuration information, and
the region specification component specifies the region on the basis of the page configuration information.

6. The image-processing unit according to claim 2, further comprising:
an information-receiving component that receives image data of one or more component images that are common among the pages (hereinafter referred to as common component image), image data of one or more component images that are variable from page to page (hereinafter referred to as a variable component image), and page configuration information indicating the position of each common component image on a page, a variable component image positioned on each of the pages, the position of each variable component image on each of the pages, and the top-bottom relationship among component images on each of the page, wherein
the common drawing data acquisition component draws image data of the common component image to thereby generate drawing data for a unit page where the common component image is positioned, on the basis of the page configuration information,
the variable drawing data acquisition component, for each of the pages, draws image data of the variable component image and generates drawing data for a unit page where the variable component image is positioned, on the basis of the page configuration information, and
the region specification component specifies the region on the basis of the page configuration information.

7. The image-processing unit according to claim 3, further comprising:
an information-receiving component that receives image data of one or more component images that are common among the pages (hereinafter referred to as common component image), image data of one or more component images that are variable from page to page (hereinafter referred to as a variable component image), and page configuration information indicating the position of each common component image on a page, a variable component image positioned on each of the pages, the position of each variable component image on each of the pages, and the top-bottom relationship among component images on each of the page, wherein
the common drawing data acquisition component draws image data of the common component image to thereby generate drawing data for a unit page where the common component image is positioned, on the basis of the page configuration information,
the variable drawing data acquisition component, for each of the pages, draws image data of the variable component image and generates drawing data for a unit page where the variable component image is positioned, on the basis of the page configuration information, and
the region specification component specifies the region on the basis of the page configuration information.

8. The image-processing unit according to claim 1, wherein
the common drawing data acquisition component receives common drawing data where one or more component images that are common among the pages (hereinafter referred to as common component image) are positioned, and stores the common drawing data in a memory,
the image-processing unit further comprises an information-receiving component that receives image data of one or more component images that are variable from page to pages (hereinafter referred to as variable component image), and page configuration information indicating the position of each of the common component images on a page, a variable component image positioned on each of the pages, the position of each of the variable component images on each of the pages, and the top-bottom relationship among the component images on each of the pages,
the variable drawing data acquisition component, for each of the pages, draws image data of the variable component image, and generates drawing data for a unit page where the variable component image is positioned, on the basis of the page configuration information,
the region specification component specifies the region on the basis of the page configuration information, and
the drawing data generation component uses the stored common drawing data and the generated variable drawing data to generate drawing data for the variable printing.

9. The image-processing unit according to claim 2, wherein
the common drawing data acquisition component receives common drawing data where one or more component images that are common among the pages (hereinafter referred to as common component image) are positioned, and stores the common drawing data in a memory,
the image-processing unit further comprises an information-receiving component that receives image data of one or more component images that are variable from page to pages (hereinafter referred to as variable component image), and page configuration information indicating the position of each of the common component images on a page, a variable component image positioned on each of the pages, the position of each of the variable component images on each of the pages, and the top-bottom relationship among the component images on each of the pages,
the variable drawing data acquisition component, for each of the pages, draws image data of the variable component image, and generates drawing data for a unit page where the variable component image is positioned, on the basis of the page configuration information,
the region specification component specifies the region on the basis of the page configuration information, and
the drawing data generation component uses the stored common drawing data and the generated variable drawing data to generate drawing data for the variable printing.

10. An image-processing unit comprising:
a common drawing data acquisition component that acquires drawing data for a unit page containing a common image (hereinafter referred to as common drawing data) in variable printing whereby a plurality of pages are printed, with each of the pages having an image that is common among the pages and an image that is variable from page to page, the images being compounded;
a variable drawing data acquisition component that acquires drawing data for a unit page containing the variable image at each of the pages (hereinafter referred to as variable drawing data) in the variable printing;
a region specification component that specifies, for each of the pages, a region where the variable image is positioned over the common image, among regions where the common image is positioned; and
a drawing data generation component that overwrites, for each of the pages, the acquired variable drawing data with the acquired common drawing data so as not to overwrite the specified region, and generates drawing data for variable printing for a unit page.

11. The image-processing unit according to claim 10, wherein
the drawing data generation component performs processing whereby pixels in the specified region in the common drawing data are set to colorless pixels, and overwrites the variable drawing data with the processed common drawing data.

12. The image-processing unit according to claim 10, wherein
the common drawing data acquisition component stores the common drawing data in a memory, and
the drawing data generation component uses the stored common drawing data to generate drawing data for the variable printing.

13. The image-processing unit according to claim 11, wherein
the common drawing data acquisition component stores the common drawing data in a memory, and
the drawing data generation component uses the stored common drawing data to generate drawing data for the variable printing.

14. The image-processing unit according to claim 10, further comprising:
an information-receiving component that receives image data of one or more component images that are common among the pages (hereinafter referred to as common component image), image data of one or more component images variable from page to page (hereinafter referred to as variable component image), and page configuration information indicating the position of each of the common component images on a page, a variable component image positioned on each of the pages, the position of each variable component image on each of the pages, and the top-bottom relationship among the component images on each of the pages, wherein
the common drawing data acquisition component draws image data of the common component image to thereby generate drawing data for a unit page where the common component image is positioned, on the basis of the page configuration information,
the variable drawing data acquisition component, for each of the pages, draws image data of the variable component image, and generates drawing data for a unit page where the variable component image is positioned, on the basis of the page configuration information, and
the region specification component specifies the region on the basis of the page configuration information.

15. The image-processing unit according to claim 11, further comprising:
an information-receiving component that receives image data of one or more component images that are common among the pages (hereinafter referred to as common component image), image data of one or more component images variable from page to page (hereinafter referred to as variable component image), and page configuration information indicating the position of each of the common component images on a page, a variable component image positioned on each of the pages, the position of each variable component image on each of the pages, and the top-bottom relationship among the component images on each of the pages, wherein
the common drawing data acquisition component draws image data of the common component image to thereby generate drawing data for a unit page where the common component image is positioned, on the basis of the page configuration information,
the variable drawing data acquisition component, for each of the pages, draws image data of the variable component image, and generates drawing data for a unit page where the variable component image is positioned, on the basis of the page configuration information, and
the region specification component specifies the region on the basis of the page configuration information.

16. The image-processing unit according to claim 12, further comprising:
an information-receiving component that receives image data of one or more component images that are common among the pages (hereinafter referred to as common component image), image data of one or more component images variable from page to page (hereinafter referred to as variable component image), and page configuration information indicating the position of each of the common component images on a page, a variable component image positioned on each of the pages, the position of each variable component image on each of the pages, and the top-bottom relationship among the component images on each of the pages, wherein
the common drawing data acquisition component draws image data of the common component image to thereby generate drawing data for a unit page where the common component image is positioned, on the basis of the page configuration information,
the variable drawing data acquisition component, for each of the pages, draws image data of the variable component image, and generates drawing data for a unit page where the variable component image is positioned, on the basis of the page configuration information, and
the region specification component specifies the region on the basis of the page configuration information.

17. The image-processing unit according to claim 10, wherein
the common drawing data acquisition component receives common drawing data where one or more component images that are common among the pages (hereinafter referred to as common component image) are positioned, and stores the common drawing data in a memory,
the image-processing unit further comprises an information-receiving component that receives image data of one or more component images that are variable from page to page (hereinafter referred to as variable component image), and page configuration information indicating the position of each of the common component images on a page, a variable component image positioned on each of the pages, the position of each of the variable component images on each of the pages, and the top-bottom relationship among the component images on each of the pages,
the variable drawing data acquisition component, for each of the pages, draws image data of the variable component image, and generates drawing data for a unit page where the variable component image is positioned, on the basis of the page configuration information,
the region specification component specifies the region on the basis of the page configuration information, and
the drawing data generation component uses the stored common drawing data and the generated variable drawing data to generate drawing data for the variable printing.

18. The image-processing unit according to claim 11, wherein
the common drawing data acquisition component receives common drawing data where one or more component images that are common among the pages (hereinafter referred to as common component image) are positioned, and stores the common drawing data in a memory,
the image-processing unit further comprises an information-receiving component that receives image data of one or more component images that are variable from page to page (hereinafter referred to as variable component image), and page configuration information indicating the position of each of the common component images on a page, a variable component image positioned on each of the pages, the position of each of the variable component images on each of the pages, and the top-bottom relationship among the component images on each of the pages,
the variable drawing data acquisition component, for each of the pages, draws image data of the variable component image, and generates drawing data for a unit page where the variable component image is positioned, on the basis of the page configuration information,
the region specification component specifies the region on the basis of the page configuration information, and
the drawing data generation component uses the stored common drawing data and the generated variable drawing data to generate drawing data for the variable printing.

19. A method for generating drawing data for variable printing, the method comprising:
acquiring drawing data for a unit page containing a common image (hereinafter referred to as common drawing data) in variable printing whereby a plurality of pages are printed, with each of the pages having an image that is common among the pages and an image that is variable from page to page, the images being compounded;
acquiring drawing data for a unit page containing the variable image (hereinafter referred to as variable drawing data) in the variable printing;
specifying, for each of the pages, a region where the common image is positioned over the variable image, among regions where the variable image is positioned; and
overwriting, for each of the pages, the acquired common drawing data with the acquired variable drawing data so as not to overwrite the specified region, and generating drawing data for variable printing for a unit page.

20. A method for generating drawing data for variable printing, the method comprising:
acquiring drawing data for a unit page containing a common image (hereinafter referred to as common drawing data) in variable printing whereby a plurality of pages are printed, with each of the pages having an image that is common among the pages and an image that is variable from page to page, the images being compounded;
acquiring drawing data for a unit page containing the variable image (hereinafter referred to as variable drawing data) in the variable printing;
specifying, for each of the pages, a region where the variable image is positioned over the common image, among regions where the common image is positioned; and
overwriting, for each of the pages, the acquired variable drawing data with the acquired common drawing data so as not to overwrite the specified region, and generating drawing data for variable printing for a unit page.

21. A computer-readable medium storing a program causing a computer to execute a process for generating drawing data for variable printing, the process comprising:
acquiring drawing data for a unit page containing a common image (hereinafter referred to as common drawing data) in variable printing whereby a plurality of pages are printed, with each of the pages having an image that is common among the pages and an image that is variable from page to page, the images being compounded;
acquiring drawing data for a unit page containing the variable image (hereinafter referred to as variable drawing data) in the variable printing;
specifying, for each of the pages, a region where the common image is positioned over the variable image, among regions where the variable image is positioned; and
overwriting, for each of the pages, the acquired common drawing data with the acquired variable drawing data so as not to overwrite the specified region, and generating drawing data for variable printing for a unit page.

22. A computer-readable medium storing a program causing a computer to execute a process for generating drawing data for variable printing, the process comprising:
acquiring drawing data for a unit page containing a common image (hereinafter referred to as common drawing data) in variable printing whereby a plurality of pages are printed, with each of the pages having an image that is common among the pages and an image that is variable from page to page, the images being compounded;
acquiring drawing data for a unit page containing the variable image (hereinafter referred to as variable drawing data) in the variable printing;
specifying, for each of the pages, a region where the variable image is positioned over the common image, among regions where the common image is positioned; and
overwriting, for each of the pages, the acquired variable drawing data with the acquired common drawing data so as not to overwrite the specified region, and generating drawing data for variable printing for a unit page.
